(19) United States
(12) Patent Application Publication
(10) Pub. No.: US 2016/0167285 A1
(43) Pub. Date: Jun. 16, 2016

(54) HOLLOW MOLDED ARTICLE MANUFACTURING APPARATUS AND MANUFACTURING METHOD

(71) Applicant: Yachiyo Industry Co., Ltd., Sayama-shi, Saitama (JP)

(72) Inventors: Takatoshi Watanabe, Saitama (JP); Kazuhiro Ohtaki, Saitama (JP); Masahiro Niihori, Saitama (JP); Hajime Kudo, Saitama (JP)

(73) Assignee: Yachiyo Industry Co., Ltd., Sayama-shi, Saitama (JP)

(21) Appl. No.: 14/908,027

(22) PCT Filed: Jul. 11, 2014
(86) PCT No.: PCT/JP2014/068537

§ 371 Date: Jan. 27, 2016

(30) Foreign Application Priority Data
Sep. 2, 2013 (JP) 2013-180887

(51) Int. Cl. B29C 51/26; B29C 49/20; B29C 49/32; B29C 51/32; B29C 51/10; B29C 51/20; B29C 51/36; B29C 49/00; B29C 49/42

(52) U.S. Cl. CPC B29C 51/267; B29C 49/0047; B29C 49/20; B29C 49/32; B29C 49/421; B29C 49/4278; B29C 51/10; B29C 51/20; B29C 51/261; B29C 51/268; B29C 51/36; B29C 51/32; B29K 2105/256

(57) ABSTRACT

In manufacturing a hollow molded article by an apparatus for manufacturing a hollow molded article, a pair of molding dies and another pair of molding dies disposed to position a sheet-like parison therebetween are provided, and the sheet-like parison is transformed into a predetermined shape. Built-in parts are fixed by piston portions to the transformed sheet-like parison, then, at a position between a portion transformed by the pair of molding dies and another portion transformed by the other pair of molding dies, the sheet-like parison is cut by a cutter. After this cutting, predetermined molding dies are faced each other to be clamped. Thereby, both of transformed sheet-like parisons are joined together to manufacture a hollow molded article.

### TECHNICAL FIELD

The present invention relates to an apparatus for manufacturing a hollow molded article like a fuel tank to be carried on an automobile and a method of manufacturing the hollow molded article.

### BACKGROUND ART

Various parts contingent on a fuel tank are incorporated in the fuel tank of an automobile as a hollow molded article. The various parts include parts concerning a valve and a pump, a part to secure the strength of the fuel tank, a part to suppress waving of the fuel, and the like. When such built-in parts are attached onto the inner wall of the fuel tank, considering labor and the like for the attachment work, it is better that built-in parts are attached during a manufacturing process for the fuel tank than the built-in parts are attached after the manufacturing of the fuel tank is finished.

There is a manufacturing apparatus described, for example, in the patent literature 1 as a related art for attaching a built-in part in the manufacturing process for a fuel tank. A fuel tank is manufactured by this manufacturing apparatus as follows. First, two sheet-like parisons are made, and the parisons are disposed to be hung down one by one on both sides of a center die provided with built-in parts. Then, the center die is held between respective recessed portion sides of a pair of molding dies via respective side parisons, and the molding dies are pushed toward the center die in directions where the molding dies approach each other, so that these dies are tightly closed.

Vacuuming is performed for the inside of the closed molding dies and the parisons are transferred to the recessed portions. Then, the built-in parts are attached to the transferred parisons by an actuator in the center die. After this, the center die is retreated while moving the respective molding dies in directions to leave from each other. In the end, the two molding dies are pushed against each other so that the respective recessed portion sides of the molding dies face each other. Thereby, a closed space is formed in the parisons. Accordingly, a fuel tank provided with built-in parts is manufactured.

### PRIOR ART LITERATURE

### Patent Literature

Patent literature 1: JP 2012-187843 A

### SUMMARY OF THE INVENTION

### Problems to be Solved by the Invention

However, because the manufacturing apparatus in the patent literature 1 is provided with the center die, it brings about upsizing of the whole of the apparatus. Furthermore, a space to retreat the center die is also necessary. Therefore, there has been a problem that a wide setting space for the manufacturing apparatus is necessary.

The present invention is created to solve such problems, and it is an object of the present invention to provide a manufacturing apparatus and a manufacturing method for a hollow molded article capable of downsizing the manufacturing apparatus and reducing the space for setting the manufacturing apparatus.

### Means for Solving the Problems

In order to solve the problems, the present invention provides an apparatus including: a first molding device having a pair of molding dies disposed to position a sheet-like parison being in a plane state between the first molding dies, the device being a device to transform a portion of the sheet-like parison into a predetermined shape; a second molding device juxtaposed with the first molding device and having a pair of molding dies disposed to position the sheet-like parison between the second molding dies, the device being a device to transform a different portion of the sheet-like parison different from the portion into a predetermined shape; a fixing device disposed in at least one of the first molding device and the second molding device, the device being a device to fix a part to the transformed sheet-like parison; a cutting device to cut the sheet-like parison at a position between the portion transformed by the first molding device and the different portion transformed by the second molding device; and a moving device to relatively move the first molding device and the second molding device so that after cutting by the cutting device, a molding die of the first molding device and a molding die of the second molding device face each other and the molding dies are clamped.

### Effect of the Invention

According to the present invention, a manufacturing apparatus and a manufacturing method for a hollow molded article, which realize downsizing the manufacturing apparatus for a hollow molded article and can reduce the space for setting the manufacturing apparatus, can be provided.

### BRIEF DESCRIPTION OF THE DRAWINGS

FIG. 1A is a front view showing the structure of a manufacturing apparatus for a hollow molded article according to an embodiment of the present invention;

FIG. 1B is a front view when built-in parts are attached to the manufacturing apparatus;

FIG. 2A is a front view of the manufacturing apparatus showing the state of hanging a sheet-like parison between molding dies positioned;

FIG. 2B is a front view of the manufacturing apparatus showing the state of having transferred the sheet-like parison to each molding die;

FIG. 2C is a front view of the manufacturing apparatus showing the state of having cut the sheet-like parison at the middle thereof;

FIG. 3A is a front view of the manufacturing apparatus showing the state of having widened the distance between the molding dies after having transferred the sheet-like parison;

FIG. 3B is a front view of the manufacturing apparatus showing the state that predetermined molding dies face each other by moving the respective molding dies upward or downward;

FIG. 3C is a front view of the manufacturing apparatus showing the state of having clamped the facing molding dies;

FIG. 4A is a sectional view of a hollow molded article in the state of being taken out of the molding dies; and

FIG. 4B is a sectional view of the hollow molded article after debarring.

### MODE FOR CARRYING OUT THE INVENTION

Hereinafter, an embodiment of the present invention will be explained with reference to the drawings.

### Structure of Embodiment

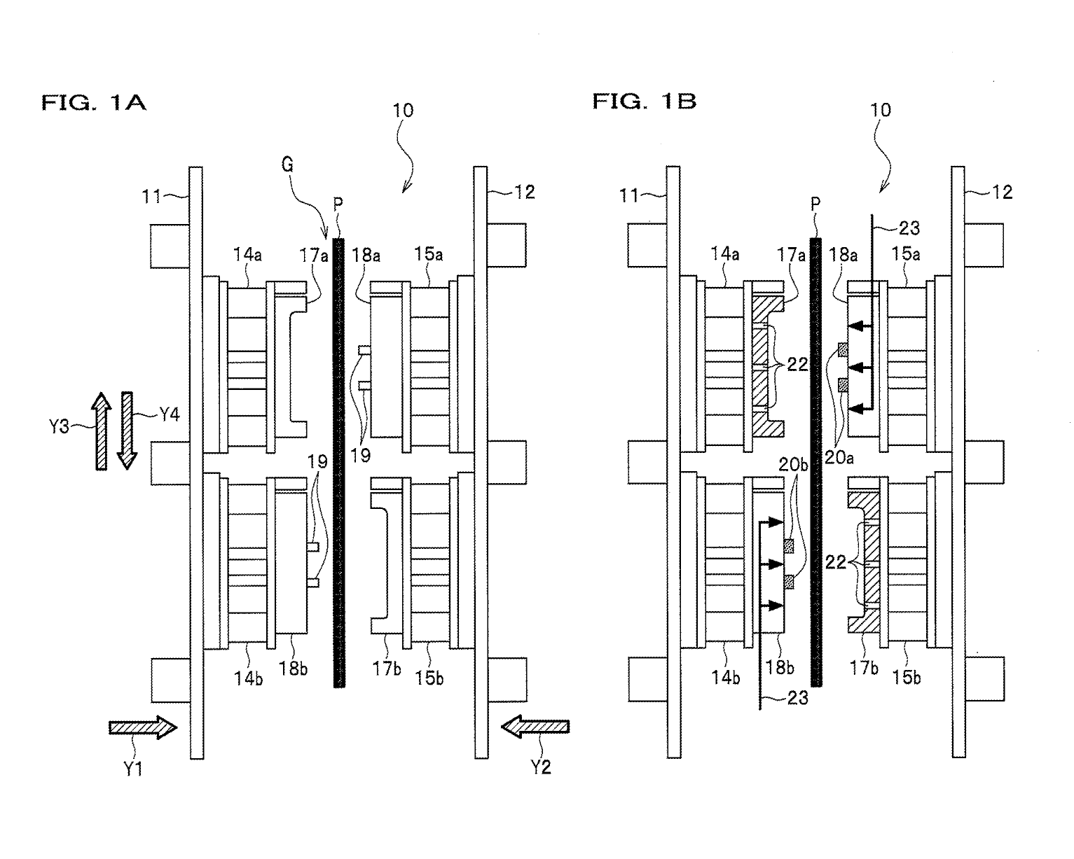

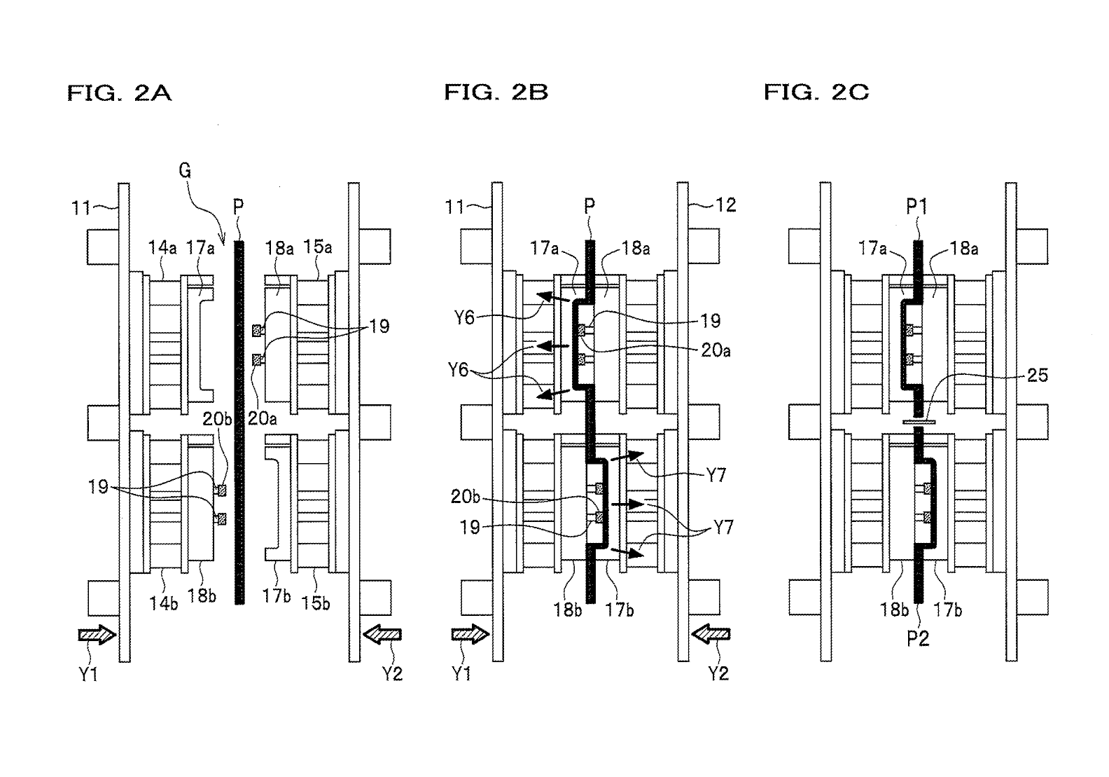

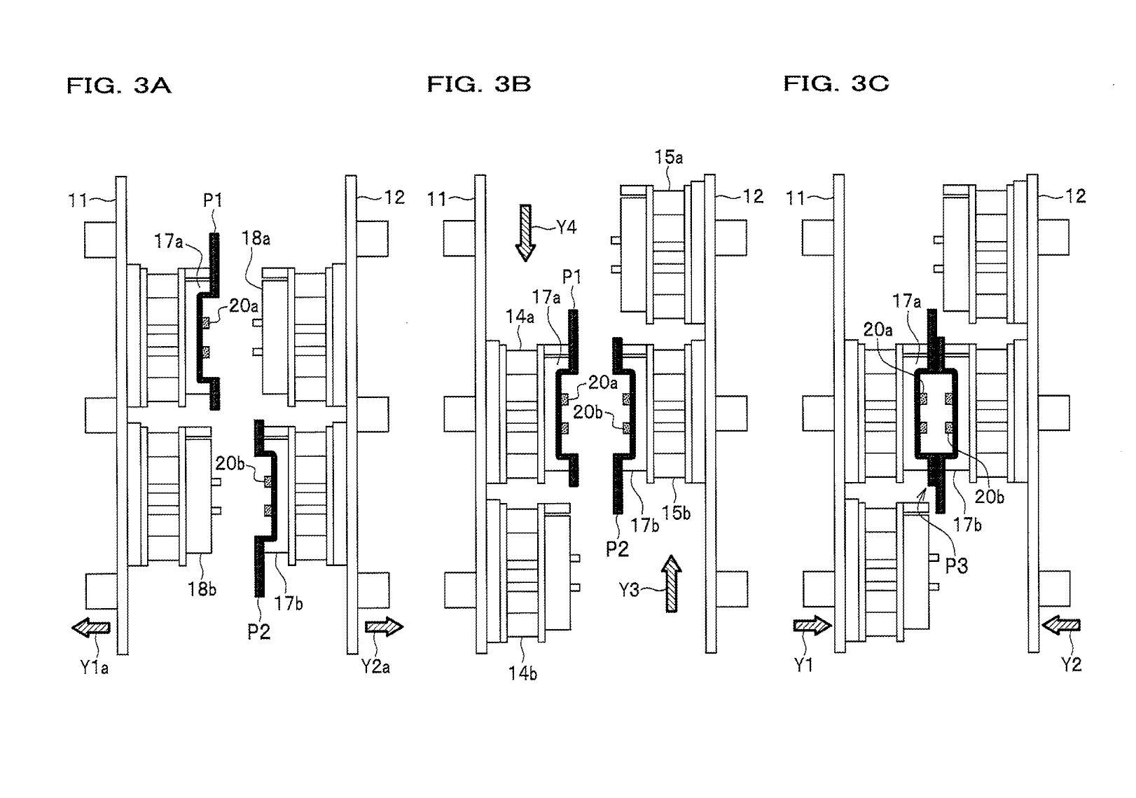

FIG. 1A is a front view showing the structure of a manufacturing apparatus for a hollow molded article according to the embodiment of the present invention, FIG. 1B is a front view when built-in parts are attached to the manufacturing apparatus. Note that, as for recessed molding dies 17a, 17b, recessed portions thereof are shown as sections. The same is said also in FIGS. 2A to 2C and FIGS. 3A to 3C which are described later.

The manufacturing apparatus 10 shown in FIG. 1A is an apparatus for forming a fuel tank of an automobile as a hollow molded article. The manufacturing apparatus 10 includes two outer rail portions 11, 12, two moving carriages 14a, 14b, and two moving carriages 15a, 15b. The two outer rail portions have respective rail surfaces which are disposed along the vertical direction to be parallel to each other while facing each other. The two moving carriages 14a, 14b are arranged on the rail of the outer rail portion 11 apart from each other with a predetermined distance in the vertical direction. The two moving carriages 15a, 15b are arranged on the rail of the other outer rail portion 12 apart from each other with the predetermined distance in the vertical direction.

Furthermore, the manufacturing apparatus 10 includes the recessed molding die (molding die) 17a, a molding die 18b, a molding die 18a, and the recessed molding die 17b. The recessed molding die 17a is fixed on the upper moving carriage 14a on the outer rail portion 11, and has the recessed portion on a surface opposite to the fixing surface. The molding die 18b is fixed on the lower moving carriage 14b, and has two piston portions 19 on a surface opposite to the fixing surface. The molding die 18a is fixed on the upper moving carriage 15a on the other outer rail portion 12, and has two piston portions 19 on a surface opposite to the fixing surface. The recessed molding die 17b is fixed on the lower moving carriage 15b, and has the recessed portion on a surface opposite to the fixing surface.

In such a structure, the recessed molding die 17a and the molding die 18a located upper on the respective outer rail portions 11, 12 face each other with a predetermined distance. In the same state as this, the lower molding die 18b and recessed molding die 17b also face each other with the predetermined distance. In this gap G having the predetermined distance, a sheet-like parison P is hung down to a position near the lower ends of the outer rail portions 11, 12. Note that, the gap G is a gap where the sheet-like parison P can be hung without coming into contact with anywhere.

The upper recessed molding die 17a and molding die 18a are a first molding device which consists of a pair facing each other while positioning the sheet-like parison P between the pair. The lower recessed molding die 17b and molding die 18b are a second molding device which consists of a pair facing each other while positioning the sheet-like parison P between the pair.

Note that, the respective recessed molding dies 17a, 17b and the respective molding dies 18a, 18b are attachable to and detachable from the moving carriages 14a, 15b, 15a, 14b.

Furthermore, the sheet-like parison P is a multi-layer plastic sheet having a barrier layer, a thermoplastic resin layer, and so on. The sheet-like parison P is, not shown, formed by cutting a parison having a cylindrical shape being hung in the vertical direction along one cutting line of a vertical line, and opening the parison to be one sheet-like parison. And furthermore, one sheet-like parison can be formed by using a known molding device.

Each piston portion 19 of each of the molding dies 18a, 18b is movable in a facing direction shown by an arrow Y1 or Y2, and in the reverse direction. Built-in parts 20a, 20b are attached to the respective piston portions 19 as shown in FIG. 1B. The attachment is performed automatically by a robot arm not shown or the like. Note that, FIG. 1A shows the state where the piston portions 19 have advanced. And FIG. 1B shows the state where the piston portions 19 have retreated.

The built-in parts 20a, 20b are various parts contingent to a fuel tank, like parts concerning a valve and/or a pump of the fuel tank, parts to secure the strength of the fuel tank, or parts to restrain waves of the fuel.

Furthermore, as shown in FIG. 1B, a plurality of through holes 22 having a small diameter are formed in parallel to one another in each of the recessed molding dies 17a, 17b, each direction of which holes is facing the molding die 18a or 18b. A vacuum pump (evacuating device) not shown is connected to the through holes 22, and evacuating is performed by the vacuum pump.

An air passage (hereinafter, a symbol 23 is also added to the passage) shown by an arrow 23 which has a plurality of branches in parallel to one another is formed in each of the molding dies 18a, 18b, each direction of which branches is facing the recessed molding die 17a or 17b. An air compressor (air blow device) not shown is connected to the passages 23, the air is blown in the facing direction through the passages 23 by air blow of the air compressor.

The moving carriages 14a, 14b and the moving carriages 15a, 15b, which are disposed on the outer rail portions 11, 12, respectively, are movable upward and downward along the outer rail portions 11, 12 as shown by arrows Y3, Y4, and can stop at a predetermined position. Note that, each movement of the moving carriages 14a, 14b, 15a, 15b is performed by using a linearly moving mechanism like a linear motor mechanism or a rack and pinion mechanism.

Each of the outer rail portions 11 and 12 is movable in the facing direction shown by the arrow Y1 or Y2 and in the reverse direction, and can stop at a predetermined position. These outer rail portion 11, 12 are also moved by a linearly moving mechanism.

Note that, a moving device is constituted by the outer rail portions 11, 12 and the moving carriages 14a, 14b, 15a, 15b which are incorporated in such a moving mechanism to move.

Moving and stopping of each of the moving carriages 14a, 14b, 15a, 15b and the outer rail portions 11, 12 are controlled by a controller not shown. The controller also controls moving and stopping of the piston portions 19. Note that, the controller is provided with, for example, a CPU (Central Processing Unit) and a memory device like a ROM (Read Only Memory), a RAM (Random Access Memory), and a HDD (Hard Disk Drive), which are not shown. The CPU executes a program stored in the memory device to control the above-mentioned moving and stopping.

Furthermore, the manufacturing apparatus 10 is provided with a cutter (cutting device) 25 to cut the sheet-like parison P in the horizontal direction as shown in FIG. 2C. The cutter 25, for example, projects to the outside from the inside of the cutting apparatus not shown, and moves to the position shown in FIG. 2C to cut the sheet-like parison P in the horizontal direction, and is housed in the cutting apparatus after cutting.

### Operation of Embodiment

Operation of the manufacturing apparatus 10 having such a structure at the time of manufacturing a fuel tank of a hollow molded article will be explained with reference to FIGS. 2A to 4B.

Moving and stopping of each of the moving carriages 14a, 14b, 15a, 15b, the outer rail portions 11, 12, and the piston portions 19 shown in FIGS. 2A to 2C are controlled by a controller not shown. Furthermore, as shown in FIGS. 2A to 2C, the recessed molding die 17a and the molding die 18b are fixed on the moving carriages 14a, 14b on the outer rail portion 11, and the molding die 18a and the recessed molding die 17b are fixed on the moving carriages 15a, 15b on the other outer rail portion 12. Note that, in FIGS. 2A to 2C, and FIGS. 3A to 3C, the through holes 22 of each of the recessed molding dies 17a, 17b and the passage 23 of each of the molding dies 18a, 18b shown in FIG. 1B are omitted.

First, as shown in FIG. 2A, the built-in parts 20a, 20b are attached to the piston portions 19 of the respective molding dies 18a, 18b by a robot arm not shown.

Second, the respective outer rail portions 11, 12 are moved in the facing directions shown by the arrows Y1 and Y2, or in the reverse directions, so that positioning is performed so that the upper recessed molding die 17a and molding die 18a face each other with a gap G, and the lower molding die 18b and recessed molding die 17b face each other with the same gap G. After this, the sheet-like parison P is hung in the gap G down to a position near the lower ends of the outer rail portions 11, 12 by a device not shown.

Next, as shown in FIG. 2B, the respective outer rail portions 11, 12 are moved in the facing directions as shown by the arrows Y1 and Y2, so that the upper recessed molding die 17a and molding die 18a, and also the lower molding die 18b and recessed molding die 17b abut against each other via the sheet-like parison P, respectively.

In the abutting state, as shown by arrows Y6, Y7, the sheet-like parison P is transferred to respective recessed portions of the recessed molding dies 17a, 17b by evacuating with use of a vacuum pump not shown. The transferred state is shown in FIG. 2B. Note that, the transferring may be done by air blow of an air compressor not shown, and it may be done at least by one of the evacuating and the air blow.

After the transferring, the respective piston portions 19 of the molding dies 18a, 18b are pushed out, so that the built-in parts 20a, 20b are pushed onto the sheet-like parison P to be attached to the parison. The attachment is performed by processing in which the built-in parts 20a, 20b are welded to the sheet-like parison P because of the heat of the parison, the built-in parts 20a, 20b are embedded into a predetermined depth of the sheet-like parison P, or the like.

Next, as shown in FIG. 2C, the cutter 25 projected from the cutting apparatus not shown is moved to a position between the upper recessed molding die 17a and molding die 18a, and the lower molding die 18b and recessed molding die 17b to cut the sheet-like parison P along the horizontal line. The sheet-like parison P is divided into an upper sheet-like parison P1 and a lower sheet-like parison P2 because of the cutting. Note that, after the cutting, the cutter 25 is housed in the cutting apparatus.

Next, as shown in FIG. 3A, the respective outer rail portions 11, 12 are moved in the reverse directions against the facing directions as shown by the arrows Y1a and Y2a, so that the recessed molding die 17a and molding die 18b disposed on the outer rail portion 11, and the molding die 18a and recessed molding die 17b disposed on the other outer rail portion 12 become apart from each other. In this time, the respective sheet-like parison P1, P2 and the respective built-in parts 20a, 20b are attached on the respective recessed portion sides of the recessed molding dies 17a, 17b.

Next, as shown in FIG. 3B, the respective moving carriages 14a, 14b on the outer rail portion 11 are moved downward as shown by the arrow Y4, and the respective moving carriages 15a, 15b on the other outer rail portion 12 are moved upward as shown by the arrow Y3, so that the respective recessed molding dies 17a, 17b are arranged in a facing state.

Next, as shown in FIG. 3C, the respective outer rail portions 11, 12 are moved in the facing directions as shown the arrows Y1 and Y2, so that the recessed portion sides of the recessed molding dies 17a, 17b are abut against each other via the sheet-like parisons P1, P2. In this time, the respective outer rail portions 11, 12 are further moved in the facing directions by a force equal to or larger than the predetermined force, so that the sheet-like parisons P1, P2 are pressed by respective peripheries of the recessed portions of the recessed molding dies 17a, 17b to be clamped. In this time, the air may be blown into the hollow space portion formed with the sheet-like parisons P1 and P2 in the closed state where the respective recessed portions of the recessed molding dies 17a, 17b abut against each other, by an air compressor not shown. Thereby, a hollow molded article P3 in which the sheet-like parisons P1, P2 are clamped is formed.

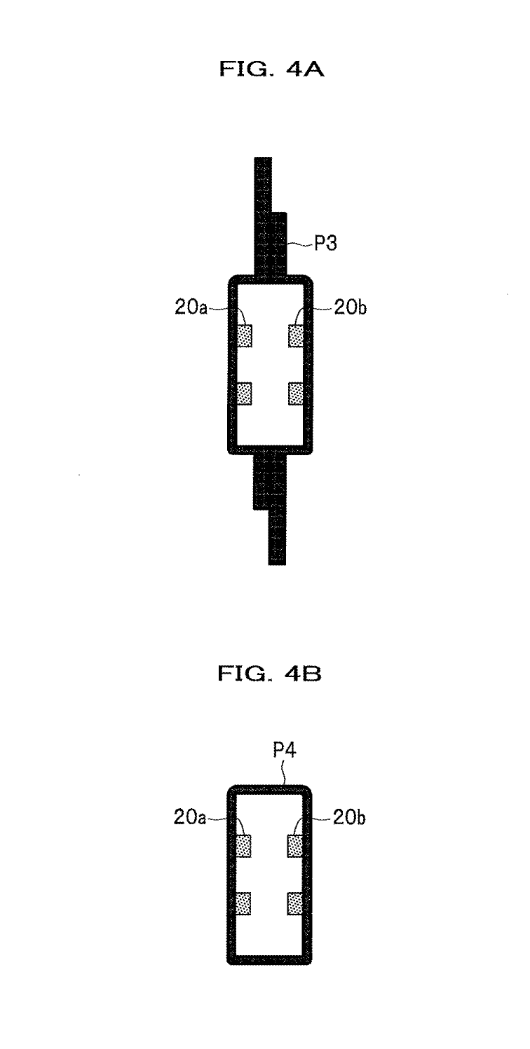

After that, the respective outer rail portions 11, 12 are moved in the reverse directions against the facing directions to make the recessed molding dies 17a, 17b separate from each other, and the hollow molded article P3 shown in FIG. 4A is taken out. Burr-portions projected upward and downward from the hollow molded article P3 are cut by a cutter or the like not shown, so that a fuel tank P4 shown in FIG. 4B is finally manufactured.

### Effect of Embodiment

As explained above, the manufacturing apparatus 10 for a hollow molded article of the present embodiment includes a first molding device which has the pair of molding dies 17a, 18a disposed with the sheet-like parison P in the form of a plane between the pair of molding dies 17a, 18a and transforms the sheet-like parison P to a predetermined form; and a second molding device juxtaposed with the first molding device, which second molding device has the pair of molding dies 18b, 17b with the sheet-like parison P in the form of a plane between the pair of molding dies 18b, 17b and transforms a different part of the sheet-like parison P different from the part of the sheet-like parison P transformed in the above to a predetermined form.

Furthermore, the manufacturing apparatus 10 includes a piston portion 19 as a fixing device which is provided in at least one of the first molding device and the second molding device to fix a part to the transformed sheet-like parison P above-mentioned; a cutter 25 as a cutting device which cuts a portion of the sheet-like parison P between the part of the sheet-like parison P transformed by the first molding device and the part of the sheet-like parison P transformed by the second molding device; and the respective outer rail portions 11, 12 and the respective moving carriages 14a, 14b, 15a, 15b as a moving device which relatively moves the first molding device and the second molding device so that after the cutting, a molding die of the first molding device and a molding die of the second molding device face each other and these molding dies are clamped.

Therefore, the manufacturing apparatus 10 of the present embodiment does not need a large center die between the facing molding dies like a conventional type apparatus. Accordingly, the manufacturing apparatus 10 can be downsized to that extent. Furthermore, as the center die is not needed, there is not needed either a space where the large center die is retreated. Therefore, a space to set the manufacturing apparatus 10 can be saved.

Furthermore, in the conventional type apparatus, when molding dies facing each other having a center die between them are moved in the facing directions, the moving distance of the molding dies is shorter only by the size of the center die disposed between them, so that the degree of freedom for design has been low.

On the other hand, a center die is not needed in the present embodiment, the depth of the recessed portion of a molding die can be enlarged to that extent, and furthermore, the moving distance of the molding dies in the facing directions can also be lengthened. Thereby, a fuel tank having a big capacity can be made. Furthermore, as the capacity of the fuel tank can be enlarged, a large built-in part, which is a part long in a height direction of the fuel tank, can be loaded.

Furthermore, each of the first molding device and the second molding device includes at least one of a vacuum pump as an evacuating device and an air compressor as an air blow device, which pump or compressor transfers the sheet-like parison P to each of the molding dies 17a, 17b.

According to this constitution, the sheet-like parison P can be drawn to or pressed on each recessed portion of the molding dies 17a, 17b, or both of the drawing and the pressing can be performed. Therefore, the sheet-like parison P can be more adequately transferred to each recessed portion of the molding dies 17a, 17b. Thereby, the molding accuracy can be enhanced.

Note that, in the above-mentioned embodiment, the outside shape of the fuel tank P4 as a hollow molded article is substantively a rectangular parallelepiped. However, by changing the shape of the recessed portion of each molding die 17a, 17b, a fuel tank or another product, which is a hollow molded article having various shapes like a substantive cylinder shape or a column shape having a substantive elliptical cross-section, can be manufactured.

Furthermore, the first molding device and the second molding device are juxtaposed in the vertical direction along the sheet-like parison P in the present embodiment. But, the first molding device and the second molding device may be juxtaposed in the lateral direction (direction of the thickness of the paper sheet showing FIGS. 1A and 1B) along the sheet-like parison P.

### DESCRIPTION OF THE SYMBOLS

10 Manufacturing apparatus
11, 12 Outer rail portion
14a, 14b, 15a, 15b Moving carriage
17a, 17b Recessed molding die (Molding die)
18a, 18b Molding die
19 Piston portion
20a, 20b Built-in part
22 Through hole
23 Passage

1-3. (canceled)

4. An apparatus for manufacturing a hollow molded article, comprising:
a first molding device including a pair of a recessed molding die and a molding die disposed to position a sheet-like parison being in a plane state between the recessed molding die and the molding die, the device being a device to transform a portion of the sheet-like parison into a predetermined shape;
a second molding device juxtaposed with the first molding device and including a pair of a recessed molding die and a molding die disposed to position the sheet-like parison between the recessed molding die and the molding die, the device being a device to transform a different portion of the sheet-like parison different from the portion into a predetermined shape;
a fixing device disposed in the molding die facing the recessed molding die of at least one of the first molding device and the second molding device, the device being a device to fix a part to the transformed sheet-like parison;
a cutting device to cut the sheet-like parison at a position between the portion transformed by the first molding device and the different portion transformed by the second molding device; and
a moving device to relatively move the first molding device and the second molding device so that after cutting by the cutting device, the recessed molding die of the first molding device and the recessed molding die of the second molding device face each other and the recessed molding dies are clamped,
wherein each of the first molding device and the second molding device comprises at least one of an evacuating device and an air blow device to transfer the sheet-like parison to a corresponding recessed molding die.

5. A method of manufacturing a hollow molded article, comprising:
a step of transforming a portion of a sheet-like parison disposed in a plane state into a predetermined shape by a recessed molding die and a molding die of a first molding device while vacuuming by an evacuating device included in the first molding device, or while air-blowing by an air blow device included in the first molding device;
a step of transforming a different portion of the sheet-like parison different from the portion into a predetermined shape by a recessed molding die and a molding die of a second molding device juxtaposed with the first molding device while vacuuming by an evacuating device included in the second molding device, or while air-blowing by an air blow device included in the second molding device;
a step of fixing a part to a corresponding transformed portion of the sheet-like parison by a fixing device included in the molding die facing the recessed molding die of at least one of the first molding device and the second molding device;
a step of cutting the sheet-like parison at a position between the portion transformed by the first molding device and the different portion transformed by the second molding device; and
a step of facing the recessed molding die of the first molding device and the recessed molding die of the second molding device each other and clamping the recessed molding dies, the step of facing and clamping being performed after the step of cutting.
